(19) United States
(12) Patent Application Publication
(10) Pub. No.: US 2017/0122709 A1
(43) Pub. Date: May 4, 2017

(54) NETWORK CONNECTION FRAMEWORK FOR CONNECTING A DARTBOARD TO A PORTABLE DEVICE

(71) Applicant: JINWEI PLASTIC MODEL HARDWARE FTY.LTD., Hong Kong (CN)

(72) Inventor: Hsien-Ta WU, Hong Kong (CN)

(73) Assignee: JINWEI PLASTIC MODEL HARDWARE FTY.LTD.

(21) Appl. No.: 15/403,918

(22) Filed: Jan. 11, 2017

Related U.S. Application Data
(63) Continuation-in-part of application No. 14/673,362, filed on Mar. 30, 2015.

(51) Int. Cl. F41J 5/14; H04L 29/08; F41J 5/04; H04W 4/00

(52) U.S. Cl. CPC F41J 5/14; H04W 4/008; H04L 67/10; F41J 5/04; H04W 84/12

(57) ABSTRACT

A network connection framework for connecting a dartboard to a portable device includes: a cloud server; a communication device communicating with the cloud server via a communication network; a dartboard including a dartboard unit, a sensing unit and a dartboard wireless communication unit which connects the dartboard to the cloud server via wireless signal, the dartboard wireless communication unit serves to receive and transmit the score signal to the could server; and a portable device with a portable device wireless communication device which connects the portable device to the cloud server via wireless signal. When the user registration information is inputted in the portable device, the score corresponding to the score signal will be displayed. Therefore, the dart game can be played by players in different venues, and consequently is not restricted by the number of the players and the size and location of the venue.

This application is a continuation-in-part of application Ser. No. 14/673,362, filed 2015 Mar. 30.

### BACKGROUND OF THE INVENTION

Field of the Invention

The present invention relates to a dart game device, and more particularly to a network connection framework for connecting a dartboard to a portable device.

Description of the Prior Art

The dart game in the early days is scored manually, which is not only inconvenient but also inaccurate. Nowadays, electronic dartboard has been used in the dart game. The electronic dartboard is provided with an electronic sensing system to which is capable of detecting the landing location that the dart is thrown on the dartboard and calculating the score corresponding to the landing location, solving the problem of inconvenience and inaccuracy of the manual scoring.

Despite it offers the function of automatic sensing and calculation, the electronic dartboard still cannot be connected to network, which results in a low applicability. In terms of entertaining, separated friends and families at different places are unable to play the dart game together. On the competition side, contestants at different places are unable to play the game together, therefore, the dart competition is restricted by the size and the location of the venue of competition.

The present invention has arisen to mitigate and/or obviate the afore-described disadvantages.

### SUMMARY OF THE INVENTION

The primary objective of the present invention is to provide a network connection framework for connecting a dartboard to a portable device, which allows the dart game to be played by players in different venues, so that the dart game is not restricted by the number of the players and the size and location of the venue (where the dart game is hold), so as to improve the applicability of the dart game.

To achieve the above objective, a network connection framework for connecting a dartboard to a portable device in accordance with the present invention comprises: a cloud server including a score database and a user database, the score database being used to calculate and store score signals and obtain a score, the user database being used to store at least one registration information; a communication device communicating with the cloud server via a communication network; the dartboard including a dartboard unit, a sensing unit and a dartboard wireless communication unit, the dartboard unit being used as a target for a dart to throw at, the sensing unit detecting a landing location the dart lands on the dartboard unit and sending out a score signal corresponding to the landing location, the dartboard wireless communication unit sending a dartboard wireless communication signal to the communication device, so as to connect the dartboard to the cloud server via wireless signal, the dartboard wireless communication unit serving to receive and transmit the score signal to the score database; and the portable device including a portable device wireless communication device which sends a portable device wireless communication signal to the communication device to connect the portable device to the cloud server via wireless signal, when the user registration information is inputted in the portable device, the score corresponding to the score signal will be displayed.

Preferably, the communication device is a router.

Preferably, the dartboard wireless communication unit is a Wi-Fi communication unit.

Preferably, the portable device is a Wi-Fi communication unit.

To achieve the above objective, another network connection framework for connecting a dartboard to a portable device in accordance with the present invention comprises: a cloud server including a score database and a user database, the score database being used to calculate and store score signals and obtain a score, the user database being used to store at least one registration information; a communication device communicating with the cloud server via a communication network; the dartboard including a dartboard unit, a sensing unit and a dartboard wireless communication unit, the dartboard unit being used as a target for a dart to throw at, the sensing unit detecting a landing location the dart lands on the dartboard unit and sending out a score signal corresponding to the landing location, the dartboard wireless communication unit sending a dartboard wireless communication signal to the communication device, so as to connect the dartboard to the cloud server via wireless signal, the dartboard wireless communication unit serving to receive and transmit the score signal to the score database; the portable device including a portable device wireless communication device which sends a portable device wireless communication signal to the dartboard wireless communication unit of the dartboard to connect the portable device to the cloud server via wireless signal, when the user registration information is inputted in the portable device, the score corresponding to the score signal will be displayed.

In other words, the portable devices are connected to the cloud server via the dartboard wireless communication unit of the dartboard. Anyhow, the dartboard of the first and second embodiments of the present invention is connected to the cloud server via the communication device and the communication network.

Preferably, the communication device is a router.

Preferably, the dartboard wireless communication unit is a Wi-Fi communication unit, and the portable device is a Wi-Fi communication unit.

Preferably, the dartboard wireless communication unit is a Bluetooth communication unit, and the portable device is a Bluetooth communication unit.

To achieve the above objective, another network connection framework for connecting a dartboard to a portable device in accordance with the present invention comprises: a cloud server including a score database and a user database, the score database being used to calculate and store score signals and obtain a score, the user database being used to store at least one registration information; a communication device communicating with the cloud server via a communication network; the dartboard including a dartboard unit, a sensing unit, a dartboard wireless communication unit, and a display unit, the dartboard unit being used as a target for a dart to throw at, the sensing unit detecting a landing location the dart lands on the dartboard unit and sending out a score signal corresponding to the landing location, the dartboard wireless communication unit sending a dartboard wireless communication signal to the portable device, the dartboard wireless communication unit serving to receive and transmit the score signal to the portable device, and the score signal is calculated by the portable device to obtain a score and then the calculated score signal is transmitted from the portable device to the dartboard wireless communication unit of the dartboard, finally the calculated score signal is transmitted from the dartboard wireless communication unit to the display unit to show the score corresponding to the score signal; and the portable device including a portable device wireless communication device which sends a portable device wireless communication signal to the cloud server via wireless signal, when the user registration information is inputted in the portable device, the score corresponding to the score signal will be displayed on the portable device and the display unit synchronously.

Preferably, the network connection framework for connecting the dartboard to the portable device may further comprise a communication device communicating with the cloud server via a communication network. And the portable device wireless communication device sends a portable device wireless communication signal to the communication device to connect the portable device to the cloud server via wireless signal.

Therefore, the score may be shown on the portable device and the display unit synchronously to make sure that the information (score) is correct and to prevent from the error of calculation between the portable device and the dartboard (display unit).

### BRIEF DESCRIPTION OF THE DRAWINGS

FIG. 1 is a flowchart view of a network connection framework for connecting a dartboard to portable devices in accordance with a first preferred embodiment of the present invention;

FIG. 2 is an illustrative view of the network connection framework for connecting a dartboard to portable devices in accordance with the first preferred embodiment of the present invention;

FIG. 3 is an operational view of the network connection framework for connecting a dartboard to portable devices in accordance with the first preferred embodiment of the present invention;

FIG. 4 is a flowchart view of a network connection framework for connecting a dartboard to portable devices in accordance with a second preferred embodiment of the present invention;

FIG. 5 is an illustrative view of the network connection framework for connecting a dartboard to portable devices in accordance with the second preferred embodiment of the present invention;

FIG. 6 is a flowchart view of a network connection framework for connecting a dartboard to portable devices in accordance with a third preferred embodiment of the present invention;

FIG. 7 is a flowchart view of the network connection framework for connecting a dartboard to portable devices in accordance with the fourth preferred embodiment of the present invention; and

FIG. 8 is an illustrative view of the network connection framework for connecting a dartboard to portable devices in accordance with a fifth preferred embodiment of the present invention;

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

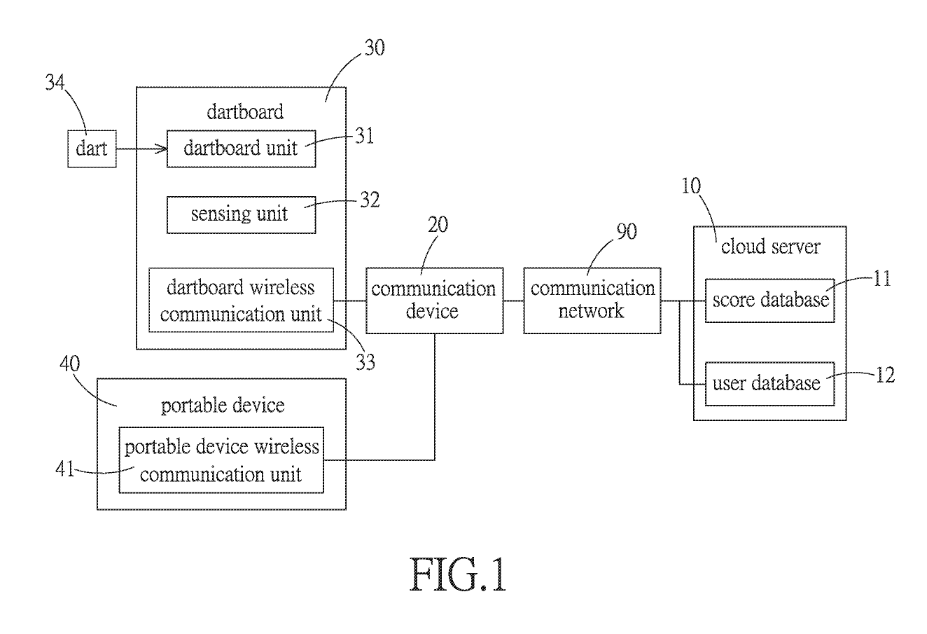

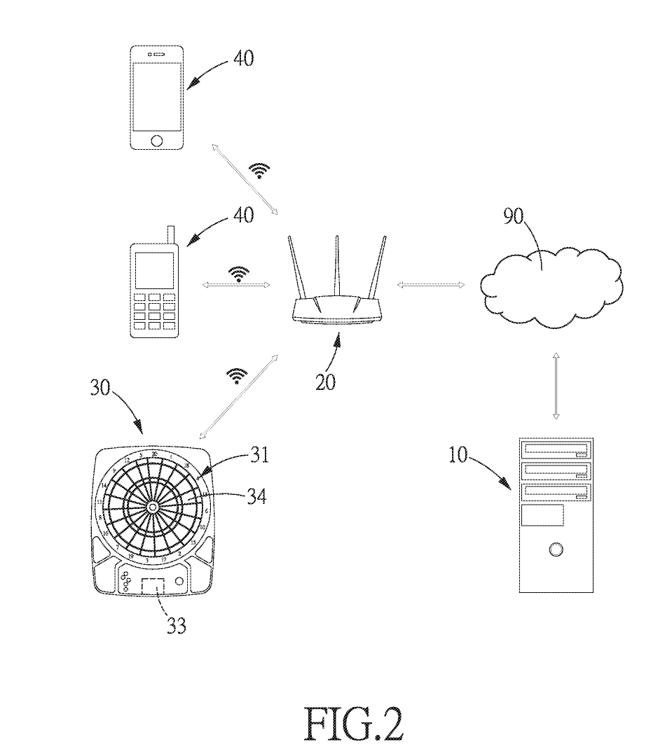

Referring to FIGS. 1 and 2, a network connection framework for connecting a dartboard to portable devices in accordance with a first preferred embodiment of the present invention comprises: a cloud server 10, a communication device 20, and two portable devices 40.

The cloud server 10 is disposed on a cloud platform which includes (but not limited to) the cloud platform provided by GOOGLE. The cloud server 10 includes a score database 11 and a user database 12. The score database 11 is used to calculate and store score signals and obtain a score. The user database 12 stores the user registration information for two users, and the user registration information can be expanded infinitely.

The communication device 20 communicates with the cloud server 10 via a communication network 90. The communication device 20 is a router in this embodiment.

The dartboard 30 includes a dartboard unit 31, a sensing unit 32 and a dartboard wireless communication unit 33. The dartboard unit 31 is used as a target for a dart 34 to throw at and divided into a plurality of areas. The sensing unit 32 detects the landing location the dart 34 lands on the dartboard unit 31 and outputs a score signal corresponding to the landing location. The dartboard wireless communication unit 33 sends a dartboard wireless communication signal to the communication device 20, to connect the dartboard 30 to the cloud server 10 via wireless signal. The dartboard wireless communication unit 33 receives and transmits the score signal to the score database 11. Namely, the communication device 20 receives the score signal, then sends it out to the score database 11 of the cloud server 10 via the communication network 90, so that the score signal is calculated by and stored in the score database 11. In this embodiment, the dartboard wireless communication unit 33 is a Wi-Fi communication unit.

The two portable devices 40 each include a portable device wireless communication device 41 which sends a portable device wireless communication signal to the communication device 20 to connect the portable device 40 to the cloud server 10 via wireless signal. The user registration information can be inputted in the portable device 40 to show and search a score corresponding to the score signal. In this embodiment, the portable device wireless communication unit 41 is a Wi-Fi communication unit.

What mentioned are the structural relations of the main components of the embodiment, and for a better understanding of the operation and function of the present invention, please refer to the following descriptions.

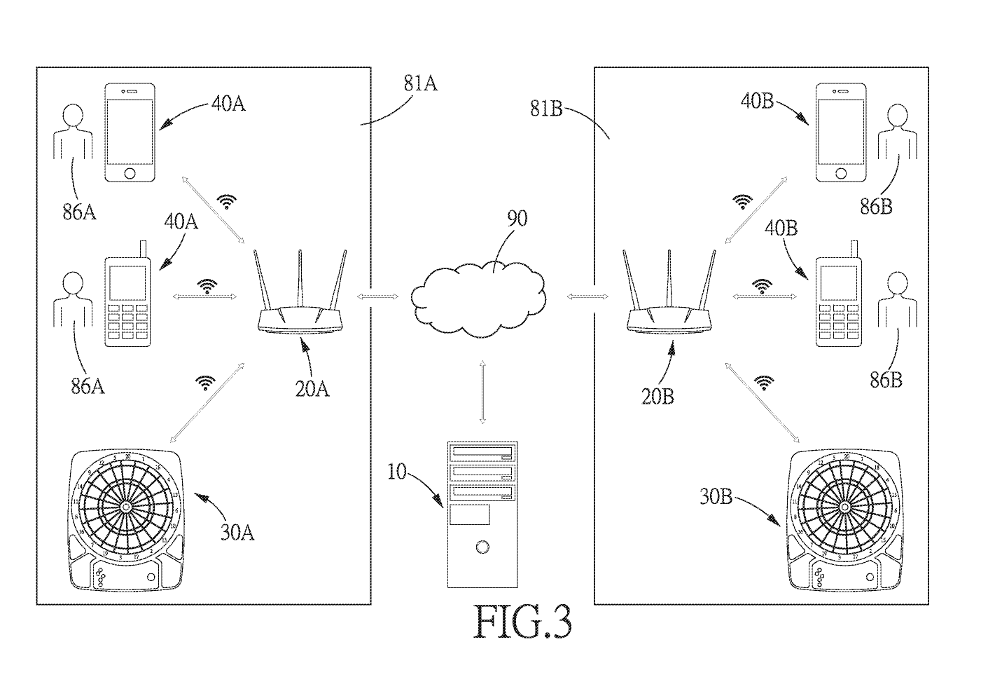

As shown in FIG. 3, there are a first communication device 20A, a first dartboard 30A and a first portable device 40A at the first location 81A, and a second communication device 20B, a second dartboard 30B and a second portable device 40B at the second location 81B. The first dartboard 30A and the first portable device 40A at the first location 81A can be signal connected to the cloud server 10 via the first communication device 20A and the communication network 90. Similarly, the second dartboard 30B and the second portable device 40B at the second location 81B can be signal connected to the cloud server 10 via the second communication device 20B and the communication network 90. When one of the first users 86A at the first location 81A throws a dart on the first dartboard 30A, the result will be calculated by and stored in the score database 11 of the cloud server 10, and a first score can be obtained. At this moment, all the first users 86A at the first location 81A can use the first portable device 40A to inquire about the first score, and all the second users 86B at the second location 81B can use the second portable device 40B to inquire about the first score in the same way.

Likewise, all the first and second users 86A,86B at the first and second locations 81A, 81B can also check out the second score that the second users 86B got by throwing dart on the second dartboard 30B at the second location 81B.

Therefore, when used in a game, the present invention allows the users at two different places to play the same dart game, which makes the game more interesting. When used in a competition, the present invention allows different contestants in different places to take part in the same competition, so that the dart competition won't be restricted by the size of the competition venue, which facilitates to the popularization and expansion of the dartboard competition.

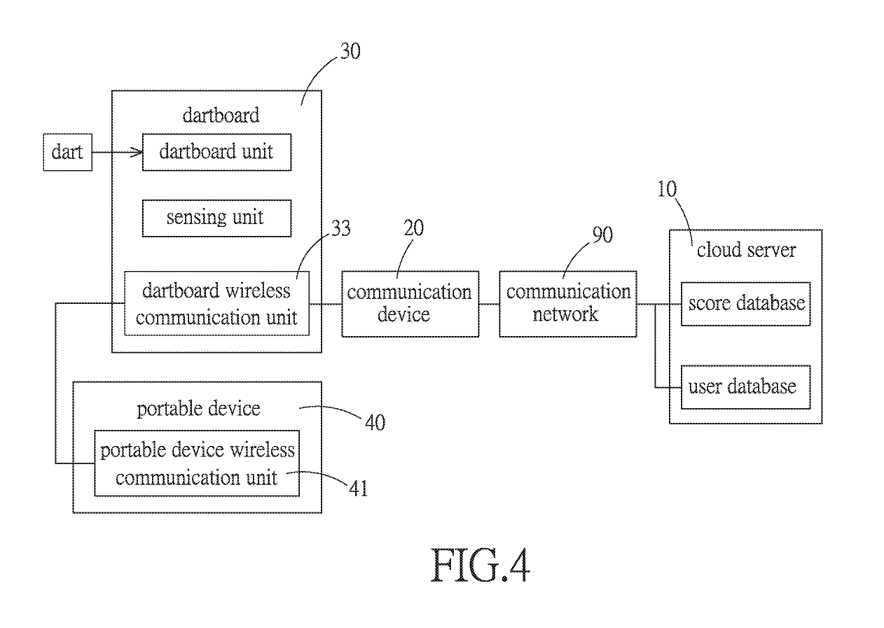

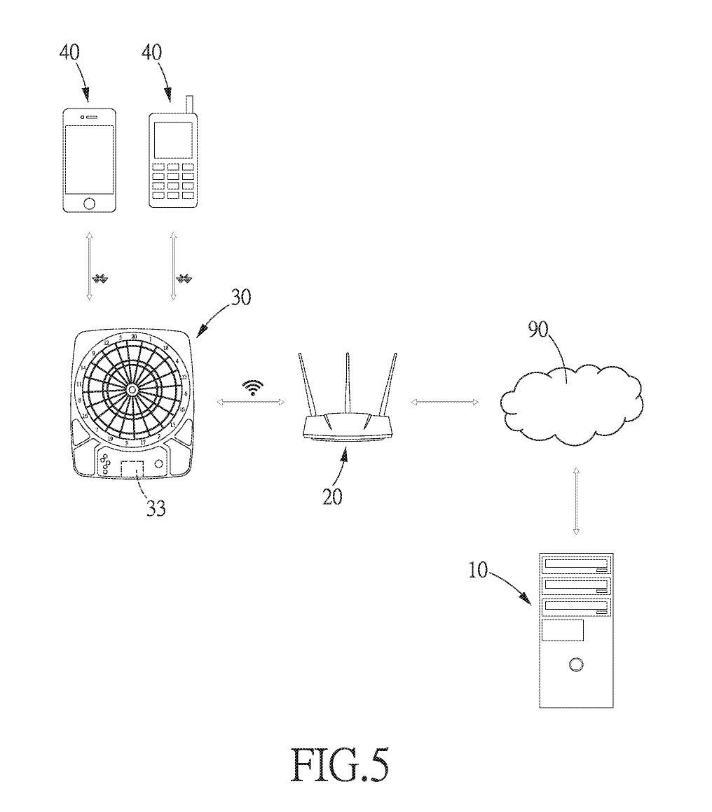

Referring to FIGS. 4 and 5, a network connection framework for connecting a dartboard to portable devices in accordance with a second preferred embodiment of the present invention is similar to the first embodiment, except that:

The two portable devices 40 each include a portable device wireless communication device 41 which sends a portable device wireless communication signal to the dartboard wireless communication unit 33 of the dartboard 30 to connect the portable devices 40 to the cloud server 10 via the dartboard 30, the communication device 20 and the communication network 90. The user registration information can be inputted in the portable device 40 to show and search a score corresponding to the score signal. In this embodiment, the dartboard wireless communication unit 33 is a Bluetooth communication unit, and the portable device wireless communication unit 41 is a Bluetooth communication unit. Of course, the dartboard wireless communication unit 33 and the portable device wireless communication unit 41 can also be a Wi-Fi communication unit.

In the second preferred embodiment, the portable devices 40 are connected to the cloud server 10 via the dartboard wireless communication unit 33 of the dartboard 30. Anyhow, the dartboard 30 of the first and second embodiments of the present invention is connected to the cloud server 10 via the communication device 20 and the communication network 90, so that, when the dartboard 30 is signal connected to the cloud server 10, the transmission of score signal and the checking of the score value will become more stable, which prevents the unstable signal transmission when the dartboard 30 is signal connected to the cloud server 10 via the portable devices 40.

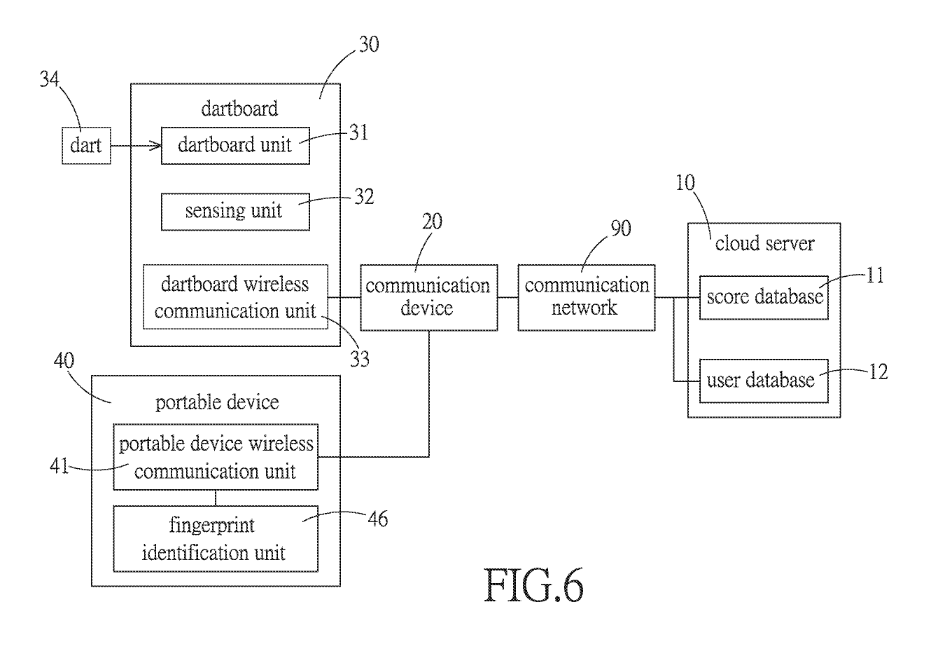

Referring then to FIG. 6, a network connection framework for connecting a dartboard to portable devices in accordance with a third preferred embodiment of the present invention is similar to the first embodiment, except that:

In addition to the portable device wireless communication unit 41, the portable devices 40 each include a fingerprint identification unit 46 which is signal connected to the portable device wireless communication unit 41. The fingerprint decertification unit 46 is used to scan the fingerprint of the user and store the distinct feature of the fingerprint, and then match the scanned fingerprint with the fingerprint information prestored in the database, so as to identify the user's identity.

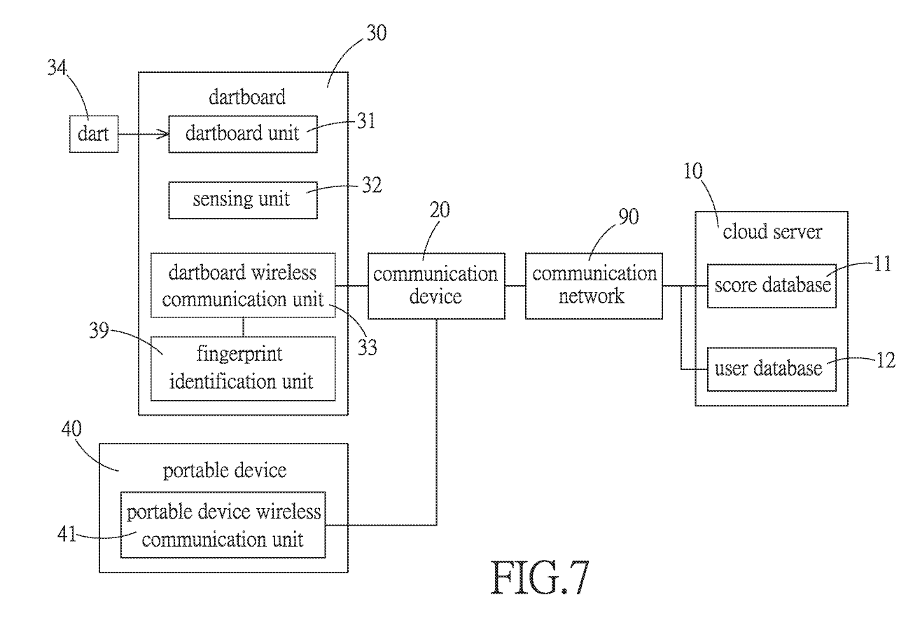

Referring then to FIG. 7, a network connection framework for connecting a dartboard to portable devices in accordance with a fourth preferred embodiment of the present invention is similar to the first embodiment, except that:

In addition to the dartboard wireless communication unit 33, the dartboard 30 further includes a fingerprint identification unit 39 which is signal connected to the dartboard wireless communication unit 33 and used to scan the fingerprint of the user and store the distinct feature of the fingerprint, and then match the scanned fingerprint with the fingerprint information prestored in the database, so as to identify the user's identity.

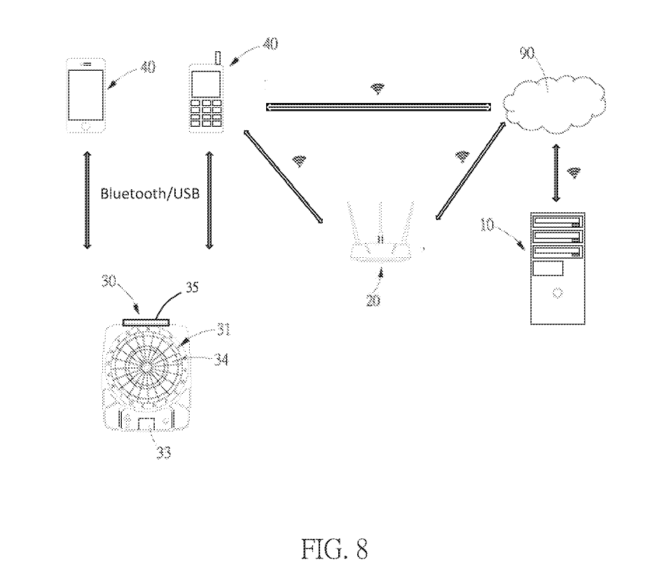

Please refer to FIG. 8, a network connection framework for connecting a dartboard to portable devices in accordance with a fifth preferred embodiment of the present invention comprises a cloud server 10 and a communication device 20.

The cloud server 10 includes a score database 11 and a user database 12. The score database 11 is used to calculate and store score signals and obtain a score. The user database 12 is used to store at least one registration information.

The communication device 20 communicates with the cloud server 10 via a communication network 90.

The dartboard 30 includes a dartboard unit 31, a sensing unit 32, a dartboard wireless communication unit 33, and a display unit 35. The dartboard unit 31 is used as a target for a dart 34 to throw at. The sensing unit 32 detects a landing location the dart 34 lands on the dartboard unit 31 and sending out a score signal corresponding to the landing location. The dartboard wireless communication unit 33 sends a dartboard wireless communication signal to the portable device 40. The dartboard wireless communication unit 33 serves to receive and transmit the score signal to the portable device 40, and the score signal is calculated by the portable device 40 to obtain a score and then the calculated score signal is transmitted from the portable device 40 to the dartboard wireless communication unit 33 of the dartboard 30. Finally, the calculated score signal is transmitted from the dartboard wireless communication unit 33 to the display unit 35 to show the score corresponding to the score signal.

The portable device 40 includes a portable device wireless communication device 41 which sends a portable device wireless communication signal to the cloud server 10 via wireless signal. Or, the portable device wireless communication device 41 may send a portable device wireless communication signal to the communication device 20 to connect the portable device 40 to the cloud server 10 via wireless signal. When the user registration information is inputted in the portable device 40, the score corresponding to the score signal will be displayed on the portable device 40 and the display unit 35 synchronously.

Preferably, the dartboard wireless communication unit 33 is a Bluetooth communication unit.

Preferably, the portable device 40 is communicated with the dartboard 30 by USB.

Therefore, the score may be shown on the portable device 40 and the display unit 35 synchronously to make sure that the information (score) is correct and to prevent the error of calculation between the portable device 40 and the dartboard 30 (display unit 35).

While we have shown and described various embodiments in accordance with the present invention, it is clear to those skilled in the art that further embodiments may be made without departing from the scope of the present invention.

What is claimed is:

1. A network connection framework for connecting a dartboard to a portable device comprising:
a cloud server including a score database and a user database, the score database being used to calculate and store score signals and obtain a score, the user database being used to store at least one registration information;
the dartboard including a dartboard unit, a sensing unit, a dartboard wireless communication unit, and a display unit, the dartboard unit being used as a target for a dart to throw at, the sensing unit detecting a landing location the dart lands on the dartboard unit and sending out a score signal corresponding to the landing location, the dartboard wireless communication unit sending a dartboard wireless communication signal to the portable device, the dartboard wireless communication unit serving to receive and transmit the score signal to the portable device, and the score signal is calculated by the portable device to obtain a score and then the calculated score signal is transmitted from the portable device to the dartboard wireless communication unit of the dartboard, finally the calculated score signal is transmitted from the dartboard wireless communication unit to the display unit to show the score corresponding to the score signal; and
the portable device including a portable device wireless communication device which sends a portable device wireless communication signal to the cloud server via wireless signal, when the user registration information is inputted in the portable device, the score corresponding to the score signal will be displayed on the portable device and the display unit synchronously.

2. The network connection framework for connecting the dartboard to the portable device as claimed in claim 1, further comprising a communication device communicating with the cloud server via a communication network.

3. The network connection framework for connecting the dartboard to the portable device as claimed in claim 2, wherein the communication device is a router.

4. The network connection framework for connecting the dartboard to the portable device as claimed in claim 1, wherein the dartboard wireless communication unit is a Bluetooth communication unit.

5. The network connection framework for connecting the dartboard to the portable device as claimed in claim 1, wherein the portable device is a Wi-Fi communication unit.

6. The network connection framework for connecting the dartboard to the portable device as claimed in claim 1, wherein the portable device is communicated with the dartboard by USB.

7. The network connection framework for connecting the dartboard to the portable device as claimed in claim 2, wherein the portable device wireless communication device sends a portable device wireless communication signal to the communication device to connect the portable device to the cloud server via wireless signal.
